(19) United States
(12) Patent Application Publication
(10) Pub. No.: US 2018/0164634 A1
(43) Pub. Date: Jun. 14, 2018

(54) ARRAY SUBSTRATE AND LIQUID CRYSTAL DISPLAY PANEL

(71) Applicant: SHENZHEN CHINA STAR OPTOELECTRONICS TECHNOLOGY CO., LTD., Shenzhen (CN)

(72) Inventor: Zhuming DENG, Shenzhen (CN)

(73) Assignee: SHENZHEN CHINA STAR OPTOELECTRONICS TECHNOLOGY CO., LTD., Shenzhen (CN)

(21) Appl. No.: 15/305,187

(22) PCT Filed: Jun. 3, 2016
(86) PCT No.: PCT/CN2016/084765

§ 371 Date: Oct. 19, 2016

(30) Foreign Application Priority Data
Apr. 12, 2016 (CN) 201610224791.5

(51) Int. Cl. G02F 1/1335; G02F 1/1343; G02F 1/1362

(52) U.S. Cl. CPC G02F 1/133514; G02F 2001/1635; G02F 1/136286; G02F 1/1343

(57) ABSTRACT

An array substrate and a liquid crystal display (LCD) panel thereof are described. The array substrate includes a bottom substrate; a thin film transistor disposed on the bottom substrate; a first passivation layer disposed on the thin film transistor and comprising a first opening which exposes the drain electrode region of the thin film transistor; a color resist layer disposed on the first passivation layer and configured to form a color filter, wherein the color resist layer comprises a second opening corresponding to the first opening to expose the drain electrode region of the thin film transistor; a pixel electrode layer disposed on the color resist layer and formed by electrically connecting the first opening and the second opening to the drain electrode region of the thin film transistor; and a second passivation layer disposed on the pixel electrode layer.

### BACKGROUND OF THE INVENTION

### Field of Invention

The present invention relates to a technical field of liquid crystal display (LCD), and more particularly to an array substrate and an LCD panel.

### Description of Prior Art

With the rapid development of technology, more and more LCD devices are widely used. To achieve the requirement of better color display in the LCD devices, a color film is formed on an array substrate of conventional LCD device to provide RGB primary colors on the array substrate, thereby avoiding the alignment between the array substrate and color filter substrate for better full color display of the LCD device. The above-described technique is termed as Color Filter on Array (COA).

FIG. 1 is a schematic structural view of a conventional COA array substrate. The COA array substrate includes a bottom substrate 101, a first metal layer 102 disposed on the bottom substrate 101 and configured to form scan lines and a gate region of a thin film field-effect transistor, a gate insulation layer 103 disposed on the first metal layer 102, a semiconductor layer 104 disposed on the gate insulation layer 103 and configured to form the channel of the thin film field-effect transistor, a second metal layer 105 disposed on the semiconductor layer 104 and configured to form a source region and a drain region of the thin film field-effect transistor and data lines, a first passivation layer 106 disposed on the second metal layer 105 and gate insulation layer 103, a color resist layer 107 disposed on the first passivation layer 106 and configured to from a color filter film, a second passivation layer 108 disposed on the color resist layer 107, and a pixel electrode layer 109 disposed on the second passivation layer 108.

To electrically connect the pixel electrode layer 109 with second metal layer 105, a plurality of openings are formed in the first passivation layer 106, color resist layer 107 and second passivation layer 108. Generally, after the opening of first passivation layer 106 is formed, the color resist layer 107 is formed, and after the opening of color resist layer 107 is formed, the second passivation layer 108 is formed. Afterwards, since the opening 110 of second passivation layer 108 are formed due to the alignment error of manufacturing procedure, the openings of first passivation layer 106 and second passivation layer 108 cannot be aligned to the opening of the color resist layer 107 completely, thereby downgrading an overlapping status between the first passivation layer 106 and second passivation layer 108. As shown in FIG. 1, the lengths L1 and L2 are depicted as dashed lines where L1 and L2 are the overlapping widths of first passivation layer 106 and second passivation layer 108 respectively. The openings of first passivation layer 106 and second passivation layer 108 shift to the right side with respect to the color resist layer 107 so that the length L2 is less than length L1 and thus, the overlapping widths of first passivation layer 106 near the length L2 are decreased. If the shifting widths of two openings are too large, the protection of the color resist layer is poor in the increased overlapping widths of first passivation layer 106 and second passivation layer 108 so that the bubble in the color resist layer exudes near the opening of color filter film, thereby downgrading the display quality of the products.

### SUMMARY OF THE INVENTION

One objective of the present invention is to provide an array substrate and a liquid crystal display (LCD) panel to prevent the bubble in the color resist layer from exuding near the opening of color filter film.

Based on the above objective, one embodiment of the present invention sets forth an array substrate. The array substrate includes a bottom substrate; a thin film transistor disposed on the bottom substrate, the thin film transistor including a first metal layer disposed on the bottom substrate and configured to form a plurality of scan lines and a gate electrode region of a thin film field-effect transistor; a first insulation layer disposed on the first metal layer; a semiconductor layer disposed on the first insulation layer and configured to form a channel region of the thin film field-effect transistor; and a second metal layer disposed on the semiconductor layer and configured to form a source electrode region and a drain electrode region of the thin film field-effect transistor and form a plurality of data lines; a first passivation layer disposed on the thin film transistor and including a first opening which exposes the drain electrode region of the thin film transistor; a color resist layer disposed on the first passivation layer and configured to form a color filter, wherein the color resist layer includes a second opening corresponding to the first opening to expose the drain electrode region of the thin film transistor, a hole diameter of the second opening is greater than a hole diameter of the first opening, and the color resist layer includes a plurality of color resists wherein two adjacent color resists therebetween form the second opening; a pixel electrode layer disposed on the color resist layer and formed by electrically connecting the first opening and the second opening to the drain electrode region of the thin film transistor; and a second passivation layer disposed on the pixel electrode layer.

In one embodiment, the array substrate includes a bottom substrate; a thin film transistor disposed on the bottom substrate; a first passivation layer disposed on the thin film transistor and including a first opening which exposes the drain electrode region of the thin film transistor; a color resist layer disposed on the first passivation layer and configured to form a color filter, wherein the color resist layer includes a second opening corresponding to the first opening to expose the drain electrode region of the thin film transistor; a pixel electrode layer disposed on the color resist layer and formed by electrically connecting the first opening and the second opening to the drain electrode region of the thin film transistor; and a second passivation layer disposed on the pixel electrode layer.

In one embodiment, the thin film transistor includes a first metal layer disposed on the bottom substrate and configured to form a plurality of scan lines and a gate electrode region of a thin film field-effect transistor; a first insulation layer disposed on the first metal layer; a semiconductor layer disposed on the first insulation layer and configured to form a channel region of the thin film field-effect transistor; and a second metal layer disposed on the semiconductor layer and configured to form a source electrode region and a drain electrode region of the thin film field-effect transistor and form a plurality of data lines.

In one embodiment, a hole diameter of the second opening is greater than a hole diameter of the first opening.

In one embodiment, the color resist layer includes a plurality of color resists and two adjacent color resists therebetween form the second opening.

In one embodiment, the color resists includes a color R resist, a color G resist and a color B resist.

In one embodiment, a liquid crystal display panel includes an array substrate and a glass substrate opposite the array substrate wherein a liquid crystal is filled into the array substrate and glass substrate therebetween, the array substrate including a bottom substrate; a thin film transistor disposed on the bottom substrate; a first passivation layer disposed on the thin film transistor and including a first opening which exposes the drain electrode region of the thin film transistor; a color resist layer disposed on the first passivation layer and configured to form a color filter, wherein the color resist layer includes a second opening corresponding to the first opening to expose the drain electrode region of the thin film transistor; a pixel electrode layer disposed on the color resist layer and formed by electrically connecting the first opening and the second opening to the drain electrode region of the thin film transistor; and a second passivation layer disposed on the pixel electrode layer.

In one embodiment, the thin film transistor includes a first metal layer disposed on the bottom substrate and configured to form a plurality of scan lines and a gate electrode region of a thin film field-effect transistor; a first insulation layer disposed on the first metal layer; a semiconductor layer disposed on the first insulation layer and configured to form a channel region of the thin film field-effect transistor; and a second metal layer disposed on the semiconductor layer and configured to form a source electrode region and a drain electrode region of the thin film field-effect transistor and form a plurality of data lines.

In one embodiment, a hole diameter of the second opening is greater than a hole diameter of the first opening.

In one embodiment, the color resist layer includes a plurality of color resists and two adjacent color resists therebetween form the second opening.

In one embodiment, the color resists includes a color R resist, a color G resist and a color B resist.

The advantage of the present invention is that the pixel electrode layer is formed under the second passivation layer. In other word, after the pixel electrode layer is formed, the second passivation layer is then formed so that it is not required to pass through the second passivation layer while electrically connecting the pixel electrode layer to the drain electrode region of the thin film transistor. Therefore, in the display region, there is no need to form openings in the second passivation layer to maintain the integrity of the second passivation layer. The integrity of the second passivation layer is capable of protecting the color resist layer to avoid the bubble in the second opening.

### BRIEF DESCRIPTION OF THE DRAWINGS

FIG. 1 is a schematic structural view of a conventional COA array substrate;

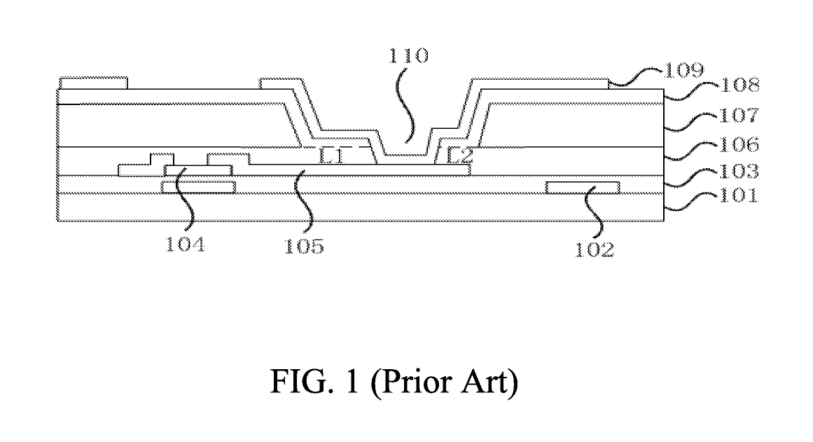

FIG. 2 is a schematic structural view of an array substrate according to one embodiment of the present invention; and

FIG. 3 is a schematic structural view of an LCD panel according to one embodiment of the present invention.

### DETAILED DESCRIPTION OF THE PREFERRED EMBODIMENTS

The following embodiments refer to the accompanying drawings for exemplifying specific implementable embodiments of an array substrate and an LCD panel of the present invention. Furthermore, directional terms described by the present invention, such as upper, lower, front, back, left, right, inner, outer, side, etc., are only directions by referring to the accompanying drawings, and thus the used directional terms are used to describe and understand the present invention, but the present invention is not limited thereto. In the drawings, the same reference symbol represents the same or a similar component.

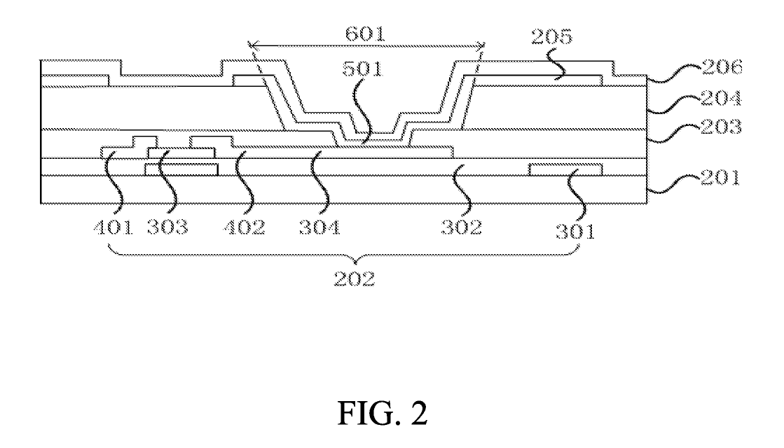

FIG. 2 is a schematic structural view of an array substrate according to one embodiment of the present invention. The array substrate includes a bottom substrate 201, a thin film transistor 202, a first passivation layer 203, a color resist layer 204, a pixel electrode layer 205 and a second passivation layer 206.

In one embodiment, the material of bottom substrate 201 is made of glass, which is configured to be a substrate of the thin film transistor 202 disposed on the bottom substrate 201.

The thin film transistor 202 includes a first metal layer 301, a first insulation layer 302, a semiconductor layer 303 and a second metal layer 304.

The first metal layer 301 disposed on the bottom substrate 201 is configured to form scan lines (not shown) and a gate electrode region of thin film transistor 202 where the material of first metal layer 301 is selected from chromium, molybdenum, aluminum and copper. The first insulation layer 302 disposed on the first metal layer 301 is configured to be a gate insulation layer where the first insulation layer 302 is composed of silicon nitride layer. The semiconductor layer 303 disposed on the first insulation layer 302 is configured to form a channel region of thin film transistor 202 where the semiconductor layer 303 is composed of amorphous silicon layer. The second metal layer 304 disposed on the semiconductor layer 303 is configured to form a source electrode region 401 and drain electrode region 402 of thin film transistor, and data lines (not shown), where the material of second metal layer 304 is selected from chromium, molybdenum, aluminum and copper.

The first passivation layer 203 disposed on the thin film transistor and includes a first opening 501 which exposes the drain electrode region 402 of thin film transistor 202.

The color resist layer 204 disposed on the first passivation layer 203 is configured to form a color filter. For example, the color filter may be RGB color resist and black matrix. The color resist layer 204 includes a second opening 601 which corresponds to the first opening 501 to expose the drain electrode region 402 of thin film transistor 202. Preferably, a hole diameter of the second opening 601 is greater than a hole diameter of the first opening 501 so that the drain electrode region 402 exposed from the first opening 501 can be completely exposed from the second opening 601. Meanwhile, the alignment between the second opening 601 and first opening 501 during the manufacturing procedures is able to prevent the offset between the second opening 601 and first opening 501.

Furthermore, the color resist layer 204 includes a plurality of color resists where two adjacent color resists therebetween form the second opening 601. In one embodiment, the color resists includes a color R resist, a color G resist, a color B resist and a color W resist. For example, the second opening 601 is disposed between the color R resist and color G resist.

The pixel electrode layer 205 is disposed on the color resist layer 204 and formed by electrically connecting the first opening 501 and second opening 601 to the drain electrode region 402 of thin film transistor 202 where the pixel electrode layer 205 is composed of indium-tin oxide. The pixel electrode layer 205 covers the color resist layer 204 and covers the first passivation layer 203, which is exposed from the second opening 601, and the drain electrode region 402, which is exposed from the first opening 501.

The second passivation layer 206 is disposed on the pixel electrode layer 205 and covers the pixel electrode layer 205 in the second opening 601. Therefore, if the second passivation layer 206 is disposed on the pixel electrode layer 205 for electrically connecting the pixel electrode layer 205 to the drain electrode region 402, there is no need to form openings in the second passivation layer 206 to maintain the integrity of the second passivation layer 206. The integrity of the second passivation layer 206 is capable of protecting the color resist layer to avoid the bubble in the second opening 601.

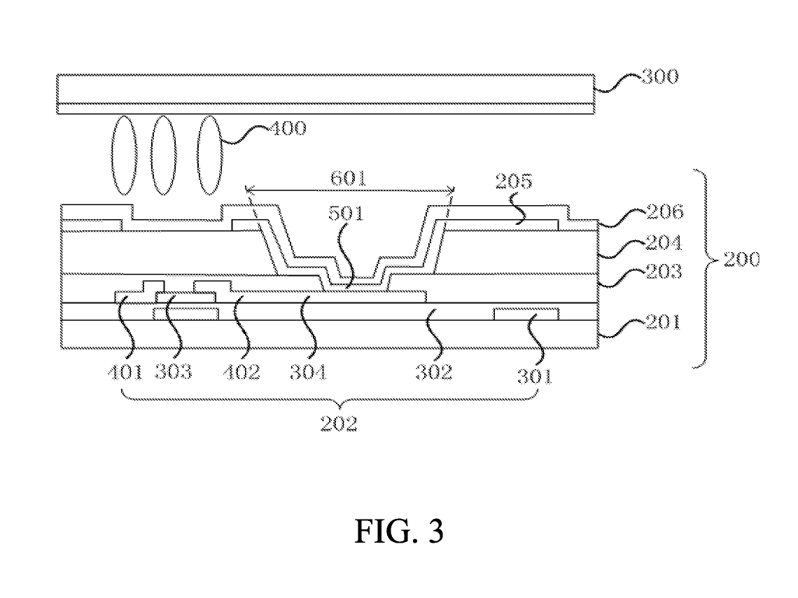

FIG. 3 is a schematic structural view of an LCD panel according to one embodiment of the present invention. The LCD panel includes an array substrate 200 and a glass substrate 300 opposite the array substrate 200 where a liquid crystal 400 is filled into the array substrate 200 and glass substrate 300 therebetween. In FIG. 2, the array substrate 200 includes a bottom substrate 201, a thin film transistor 202, a first passivation layer 203, a color resist layer 204, a pixel electrode layer 205 and a second passivation layer 206 where the array substrate 200 is similar to or the same as the array substrate in the above-mentioned descriptions.

As is understood by a person skilled in the art, the foregoing preferred embodiments of the present invention are illustrative rather than limiting of the present invention. It is intended that they cover various modifications and similar arrangements be included within the spirit and scope of the present invention, the scope of which should be accorded the broadest interpretation so as to encompass all such modifications and similar structure.

What is claimed is:

1. An array substrate, comprising:
a bottom substrate;
a thin film transistor disposed on the bottom substrate, the thin film transistor comprising:
a first metal layer disposed on the bottom substrate and configured to form a plurality of scan lines and a gate electrode region of a thin film field-effect transistor;
a first insulation layer disposed on the first metal layer;
a semiconductor layer disposed on the first insulation layer and configured to form a channel region of the thin film field-effect transistor; and
a second metal layer disposed on the semiconductor layer and configured to form a source electrode region and a drain electrode region of the thin film field-effect transistor and form a plurality of data lines;
a first passivation layer disposed on the thin film transistor and comprising a first opening which exposes the drain electrode region of the thin film transistor;
a color resist layer disposed on the first passivation layer and configured to form a color filter, wherein the color resist layer comprises a second opening corresponding to the first opening to expose the drain electrode region of the thin film transistor, a hole diameter of the second opening is greater than a hole diameter of the first opening, and the color resist layer comprises a plurality of color resists wherein two adjacent color resists therebetween form the second opening;
a pixel electrode layer disposed on the color resist layer and formed by electrically connecting the first opening and the second opening to the drain electrode region of the thin film transistor; and
a second passivation layer disposed on the pixel electrode layer.

2. The array substrate of claim 1, wherein the color resists comprises a color R resist, a color G resist and a color B resist.

3. An array substrate, comprising:
a bottom substrate;
a thin film transistor disposed on the bottom substrate;
a first passivation layer disposed on the thin film transistor and comprising a first opening which exposes the drain electrode region of the thin film transistor;
a color resist layer disposed on the first passivation layer and configured to form a color filter, wherein the color resist layer comprises a second opening corresponding to the first opening to expose the drain electrode region of the thin film transistor;
a pixel electrode layer disposed on the color resist layer and formed by electrically connecting the first opening and the second opening to the drain electrode region of the thin film transistor; and
a second passivation layer disposed on the pixel electrode layer.

4. The array substrate of claim 3, wherein the thin film transistor comprises:
a first metal layer disposed on the bottom substrate and configured to form a plurality of scan lines and a gate electrode region of a thin film field-effect transistor;
a first insulation layer disposed on the first metal layer;
a semiconductor layer disposed on the first insulation layer and configured to form a channel region of the thin film field-effect transistor; and
a second metal layer disposed on the semiconductor layer and configured to form a source electrode region and a drain electrode region of the thin film field-effect transistor and form a plurality of data lines.

5. The array substrate of claim 3, wherein a hole diameter of the second opening is greater than a hole diameter of the first opening.

6. The array substrate of claim 3, wherein the color resist layer comprises a plurality of color resists and two adjacent color resists therebetween form the second opening.

7. The array substrate of claim 3, wherein the color resists comprises a color R resist, a color G resist and a color B resist.

8. A liquid crystal display panel comprising an array substrate and a glass substrate opposite the array substrate wherein a liquid crystal is filled into the array substrate and glass substrate therebetween, the array substrate comprising:
a bottom substrate;
a thin film transistor disposed on the bottom substrate;
a first passivation layer disposed on the thin film transistor and comprising a first opening which exposes the drain electrode region of the thin film transistor;
a color resist layer disposed on the first passivation layer and configured to form a color filter, wherein the color resist layer comprises a second opening corresponding to the first opening to expose the drain electrode region of the thin film transistor;
a pixel electrode layer disposed on the color resist layer and formed by electrically connecting the first opening and the second opening to the drain electrode region of the thin film transistor; and
a second passivation layer disposed on the pixel electrode layer.

9. The liquid crystal display panel of claim 8, wherein the thin film transistor comprises:
a first metal layer disposed on the bottom substrate and configured to form a plurality of scan lines and a gate electrode region of a thin film field-effect transistor;
a first insulation layer disposed on the first metal layer;
a semiconductor layer disposed on the first insulation layer and configured to form a channel region of the thin film field-effect transistor; and
a second metal layer disposed on the semiconductor layer and configured to form a source electrode region and a drain electrode region of the thin film field-effect transistor and form a plurality of data lines.

10. The liquid crystal display panel of claim 8, wherein a hole diameter of the second opening is greater than a hole diameter of the first opening.

11. The liquid crystal display panel of claim 8, wherein the color resist layer comprises a plurality of color resists and two adjacent color resists therebetween form the second opening.

12. The liquid crystal display panel of claim 8, wherein the color resists comprises a color R resist, a color G resist and a color B resist.
